(19) United States
(12) Patent Application Publication
(10) Pub. No.: US 2005/0018615 A1
(43) Pub. Date: Jan. 27, 2005

(54) Media transmitting method, media receiving method, media transmitter and media receiver

(76) Inventors: Tomoaki Itoh, Kanagawa (JP); Takao Yamaguchi, Tokyo (JP); Ichiro Takei, Tokyo (JP); Yoshinori Matsui, Nara (JP); Youji Notoya, Osaka (JP)

Correspondence Address: Lawrence A Ashery;Ratner & Prestia, Suite 301 One Westlakes Berwyn, P O Box 980, Valley Forge, PA, 19482-0980, US

(21) Appl. No.: 10/497,361

(22) PCT Filed: Mar. 11, 2003
(86) PCT No.: PCT/JP03/02839

(30) Foreign Application Priority Data
Mar. 12, 2002 (JP) 2002-066468
Feb. 12, 2003 (JP) 2003-033386

(51) Int. Cl. H04L 12/56

(52) U.S. Cl. 370/252; 370/412

(57) ABSTRACT

Provided is a content classifying section 203 for classifying and bundling to-be-transmitted contents on the basis of any piece of information of media kind, IP address, port number and session identifier. A packet header compressing section 204 carries out header compression on the transmission packet. Due to this, because contents can be packet-transferred with efficiency and excellent error resistance by the use of a communication and broadcast network, it is possible to realize, even on the Internet for broadcast in a broadcast form, a quality broadcast free of image or sound discontinuity as the terrestrial-wave TV broadcast.

### TECHNICAL FIELD

This invention relates to a media transmitting method, media receiving method, media transmitter and media receiver, for packet-transmitting contents through using a communication or broadcast network.

### BACKGROUND ART

Conventionally, in media transmission, where providing the same program over to a multiplicity of viewers, efficiency is greater with broadcast-type distribution as represented by terrestrial-wave broadcast than one-to-one communication-type distribution, in respect of saving transmission band. Also, besides simultaneous reproduction of video images and audio sound, it is a practice to control and reproduce on-screen arrangement and reproducing timing of medias including texts, still images and animations. As for a system for reproducing such a plurality of medias, there is a proposal described in W098/06222, for example.

FIG. 17 is a configuration diagram of a conventional image decoding/encoding apparatus.

In FIG. 17, the decoding apparatus 1710 has a reception control section 1711 for receiving information, a separating section 1712 for analyzing and separating the received information, a priority determining section 1713 for determining a priority of processing the image separated by the separating section 1712, an image decompressing section 1714 for decompressing the image according to the determined priority, an image synthesizing section 1715 for image synthesis on the basis of the decompressed image, a synthesis-result storing section 1716 for storing the synthesized image, a reproducing-time managing section 1717 for managing the time to start reproduction, an output section 1718 for outputting a synthesis result according to the information of the reproducing-time managing section 1717, a time information control section 1719 for controlling the information concerned with a time, an image decompression control section 1720 for controlling the status of decompression image, an input section 1721 for inputting an information, a terminal control section 1722 for controlling these sections, and a transmission control section 1723 for transferring a priority.

Meanwhile, in the IP network for packet transmission, there is defined a scheme of one-to-multiplicity distribution including broadcast and multicast. The use of the scheme makes it possible to efficiently provide programs to a multiplicity of users. However, in case the conventional broadcast network scheme is directly applied onto the IP network, there is difficulty in efficiently distributing the programs.

For example, on the IP network, data is transferred by packeting differently from the broadcast network. Because the packet is given with a header, the header part acts as overhead to increase transmission data amount. For reducing the overhead, header compression technique is effective. JP-A-08-204778 proposes a method that whether header compression is possible or not is communicated between data terminal units thereby making a negotiation. FIG. 18 is a figure showing the conventional TCP/IP Local Area Network (LAN) connection described in JP-A-08-204778.

In FIG. 18, a local data terminal (DTE) node 1801 having a capability of using RFC1144 TCP/IP header compression/decompression is negotiating with an unknown remote local data terminal node 1802 located at the other end of the TCP/IP/X.25, to determine whether or not a remote DTE is to support for RFC1144 TCP/IP header compression/decompression.

Meanwhile, on the IP network, packet loss possibly takes place due to transmission congestion or errors, which disables program data restoration at the reception end. The solution to the problem includes a method of repeatedly sending program data. This, however, requires to specify a loss packet.

Concerning such a method, there is a description in JP-A-2000-231518. FIG. 19 is a block configuration diagram of a conventional remote file control system described in JP-A-2000-231518.

In FIG. 19, a remote file control unit 1901 has a channel adapter 1902 configuring an interface to the host processor 1900, a remote adapter 1903, 1904 for data transfer with another file control unit 1910 by the use of a line 1908, 1909, and a resource manager 1905 for managing the channel adapter 1902 and remote adapter 1903, 1904, wherein transferred data is stored in a device 1907. In the remote file control unit 1901, the resource manager 1905 is provided with signal-notification monitor means 1906 to be notified of all the packets reception from the remote adapter. In the case that there is no arrival of an all-packet reception notification from a remote adapter first to request for start, when an all-packet reception notification arrives from a remote adapter late to issue a start request, it is determined that the final packet loss have occurred at the remote adapter first to request for start. This is forwarded by a packet loss notification and process suspension notification. Due to this, proposed is a method of detecting at high speed the loss of the final packet for a non-repetition data known in the number of reception packets. Also, in DSM-CC (Digital Storage Media Command and Control: ISO/IEC 13818-6), it is possible to detect at high speed a loss of the final packet.

However, in the conventional configuration, there is a problem in concerned with header compression that, in the case a plurality of programs or contents (not only medias such as program configuring data, video images, sound and texts but also includes control information) are sent to a plurality of ports or IP addresses, irregular transmission leads to lowered header information redundancy and hence lowered header compression efficiency.

Namely, the header compression of IP packet can be made with high redundancy and efficiency where the IP address or destination port number is always constant. However, in the case the destination address or destination port exists in plurality and changes irregularly, the redundancy of this portion lowers to lower compression efficiency. This problem cannot be solved by mere negotiation on the possibility of header compression as in JP-A-08-204778.

Also, JP-A-2000-231518 and DSM-CC has the problem that, in the case the number of received packets is not known, it is impossible to detect packet loss and hence packet complement with repeated transmission.

### DISCLOSURE OF THE INVENTION

It is an object of the present invention to provide a media transmitter and media receiver which carries out packet transmission of a content with efficiency and excellence in error resistance by using a communication or broadcast network whereby, in the case of a broadcast in a broadcast form, a quality broadcast as in the terrestrial-wave TV broadcast is realized free of image or sound discontinuity even on the Internet.

A media transmitting method according to the present invention includes: a step of classifying and bundling a content divided into transmission packets on the basis of header information of the transmission packet; and a step of carrying out header compression on the transmission packets classified and bundled.

Also, classification in the invention is according to any of a media kind, IP address, port number and session identifier that are the header information.

Because this can improve the efficiency of header compression, the quality data even high in resolution can be sent without enhancing network transmission capability.

Also, in the media transmitting method of the invention, key frames, as transmission packets not to be compressed at headers, are periodically inserted in the header compression step, further comprising a step of carrying out an interleave process on the transmission packets correspondingly to the key frames.

Due to this, the packets classified and bundled according to header information, after efficiently header-compressed, can be subjected to interleave based on the key frame generated upon header compression. Thus, high header compression ratio can be kept even if interleave is done.

Also, the divided transmission packet, in the media transmitting method of the invention, is added with first identification information representative of the transmission packet unambiguously, and second identifying information for identifying a transmission packet at a start edge of the content and a transmission packet at an end edge. A step is further comprised of repeatedly transmitting the same one of the transmission packet.

Due to this, even where there is a missing transmission packet on the IP network, the media receiver can detect it and complement for the same.

A media receiving method according to the invention comprises: a step of repeatedly receiving the transmission packet sent by the media transmission method according to the invention; a step of extracting the first identifying information and second identifying information from the transmission packet; a step of detecting a missing transmission packet from the sequence number, time stamp and identifying information; and a step of extract and complement the missing transmission packet from a transmission packet next repeatedly received.

Due to this, even where there is a missing transmission packet on the IP network, it is possible to detect the missing transmission packet and complement for it by using a same transmission packet thereafter received.

A media transmitter according to the invention comprises: a packet classifying section for classifying and bundling a content divided into transmission packets on the basis of header information; and a header compressing section for carrying out header compression on the transmission packets classified and bundled.

Also, classification in the invention is according to any of a media kind, IP address, port number and session identifier that are the header information.

Because this can improve header compression efficiency, it is possible to send even quality data having high resolution without enhancing network transmission capability.

Also, in the media transmitter of the invention, the packet header compressing section has a function of periodically inserting key frames, as transmission packets not to be compressed at headers. Further comprised is an interleave section for carrying out an interleave process on the transmission packets correspondingly to the key frames.

Due to this, the packets classified and bundled, after efficiently header-compressed, can be subjected to interleave based on the key frame generated upon header compression. Thus, high header compression ratio can be kept even if interleave is done.

Also, in the media transmitter of the invention, the divided transmission packet is added with first identification information representative of the transmission packet unambiguously, and second identifying information for identifying a transmission packet at a start edge of the content and a transmission packet at an end edge. A transmitting section is further comprised for repeatedly transmitting the same one of the transmission packets.

Due to this, even where there is a missing transmission packet on the IP network, the media receiver can detect it and complement for the same.

A media receiver according to the invention comprises: an acquiring section for extracting the first identifying information and the second identifying information from a transmission packet received by the media transmitter according to the invention; a missing packet detecting section for detecting a missing transmission packet by using the extracted first identifying information and the second identifying information; and a data complement section for extracting a same transmission packet missing transmission packet from a transmission packets repeatedly received.

As described above, according to the invention, a content can be sent with efficiency and excellence in error resistance by using a communication or broadcast network whereby, even on the Internet for broadcast in a broadcast form, a quality broadcast is realized free of image or sound discontinuity as in the terrestrial-wave TV broadcast.

### BRIEF DESCRIPTION OF THE DRAWINGS

FIG. 1A is a diagram showing a utilization form of a communication network in a first embodiment of the present invention.

FIG. 1B is a diagram showing a utilization form of a communication network in the first embodiment of the invention.

FIG. 2 is a diagram showing a content broadcast scheme in the first embodiment of the invention.

FIG. 3A is a flowchart showing a packet classifying process in the first embodiment of the invention.

FIG. 3B is a figure showing a classification queue in the first embodiment of the invention.

FIG. 4 is a flowchart showing a header compressing process in the first embodiment of the invention.

FIG. 5A is a figure showing the amount of data in the case of not carrying out the header compression in the first embodiment.

FIG. 5B is a figure showing the amount of data in the case of carrying out the header compression in the first embodiment.

FIG. 6 is a flowchart showing an interleave process in the first embodiment of the invention.

FIG. 7 is a flowchart showing the operation of a media receiver in the first embodiment of the invention.

FIG. 8 is a block configuration diagram of a data reproducing section in the first embodiment of the invention.

FIG. 9 is a flowchart showing the operation of a data reproducing section in the first embodiment of the invention.

FIG. 10 is a figure showing a transmission timing of program information, structure information and media data in the first embodiment of the invention.

FIG. 11A is a figure showing the conventional program information.

FIG. 11B is a figure showing the conventional structure information.

FIG. 12 is a figure showing a method to complement for a missing packet in the first embodiment of the invention.

FIG. 13A is a figure showing program information in the first embodiment of the invention.

FIG. 13B is a figure showing an RTP extension header in a second embodiment of the invention.

FIG. 14 is a flowchart showing a complement process for a missing packet in the first embodiment of the invention.

FIG. 15 is a block configuration diagram showing a data reproducing section in the second embodiment of the invention.

FIG. 16 is a flowchart showing a complement process for a missing packet in the second embodiment of the invention.

FIG. 17 shows a configuration diagram of a conventional image decoding/encoding apparatus.

FIG. 18 shows a conventional TCP/IP Local Area Network connection.

FIG. 19 is a block configuration diagram of a conventional remote file control system.

### BEST MODE FOR CARRYING OUT THE INVENTION

Hereunder, embodiments of the present invention will be explained in conjugation with the drawings.

(First Exemplary Embodiment)

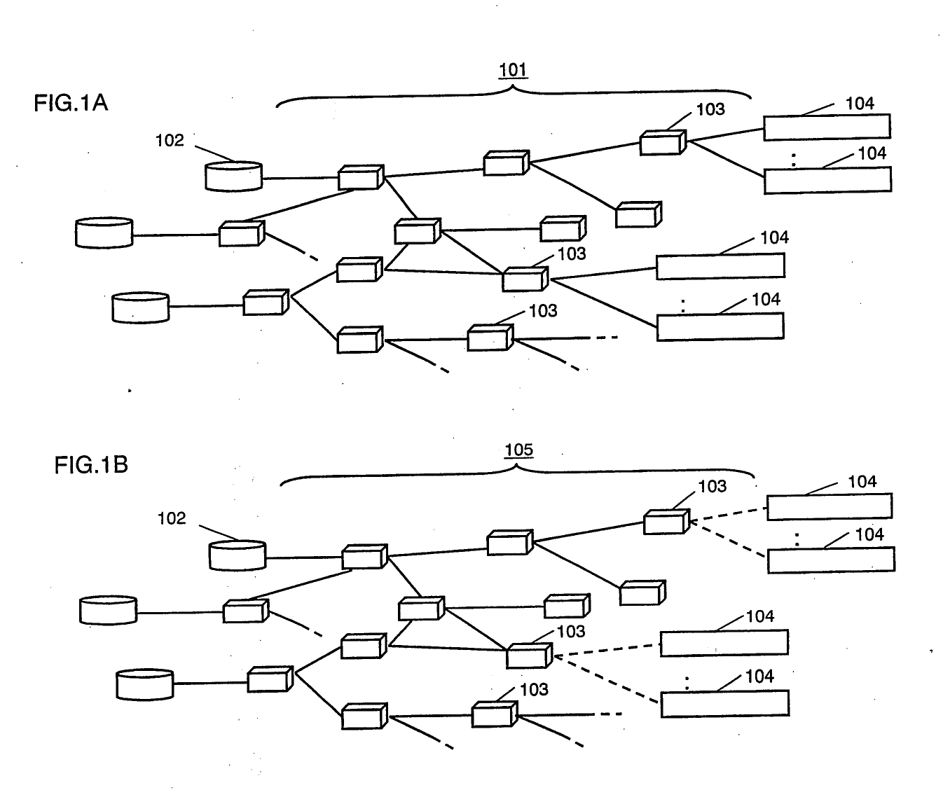

FIGS. 1A and 1B show a utilization form of a communication network in a first embodiment of the invention.

In FIG. 1A, servers 102 are media transmitters of the invention while terminal units 104 are media receivers of the invention. Meanwhile, a network 101 may be a wired network (e.g. ADSL, ISDN, ATM or FTTH) or a wireless network (e.g. cellular phone or radio RAN). In FIG. 1B, although the configuration is by a wired network at from the server 102 to the relay node 103 and by a wireless network therefrom to the reception terminal unit 104, it may be a communication network 105 interconnected with such wired and wireless networks. The transmission protocol uses an Internet protocol, while communication units are mutually connected by relay nodes 103, such as refuters and GWs (gateways). The routers and GWs have a broadcast or multicast function so that a data packet can be duplicated at the router and GW.

Also, the content transmitting method may use 1-to-1 communication at between the server 102 and the reception terminal unit 104. Otherwise, a broadcast or multicast function may be employed for 1-to-N communication. In this embodiment, multicast is applied at between tide server 102 and the relay node 103 while broadcast is used at between the relay node 103 and the reception terminal unit. This allows the reception terminal unit 104 to receive a recent content by opening a predetermined channel.

Transmission contents are various medias, including moving images, sound, music, texts, still images and layout information.

The reception terminal units 104 may be terminals different in display resolution or process capability, e.g. cellular phones, TV sets, and personal computers.

Also, the distribution servers 102 may exist in plurality so that the reception terminal units 104 may simultaneously receive contents from the plurality of servers 102.

Furthermore, besides the communication network 101, the system configuration may be with a broadcast network (e.g. terrestrial wave digital broadcast, satellite digital broadcast) or a fusion of broadcast and communication networks. Particularly, in the case of broadcast contents to the moving reception terminal unit such as the cellular phone, there is a demand for broadcasting different contents on a region-by-region basis. In such a case, in case broadcast or multicast is done from the server onto a plurality of reception terminal units, it is not easy to change the broadcast content as required depending upon the location.

In order to realize a broadcast suited for the location, the FIG. 1B example utilizes 1-to-1 unicast communication at between the server 102 and the relay node 106 (wired-network zone) and a broadcast function for distribution at between the relay node 106 and the reception terminal unit. The relay node 106 realizing the broadcast function does not broadcast packets beyond another relay node 106.

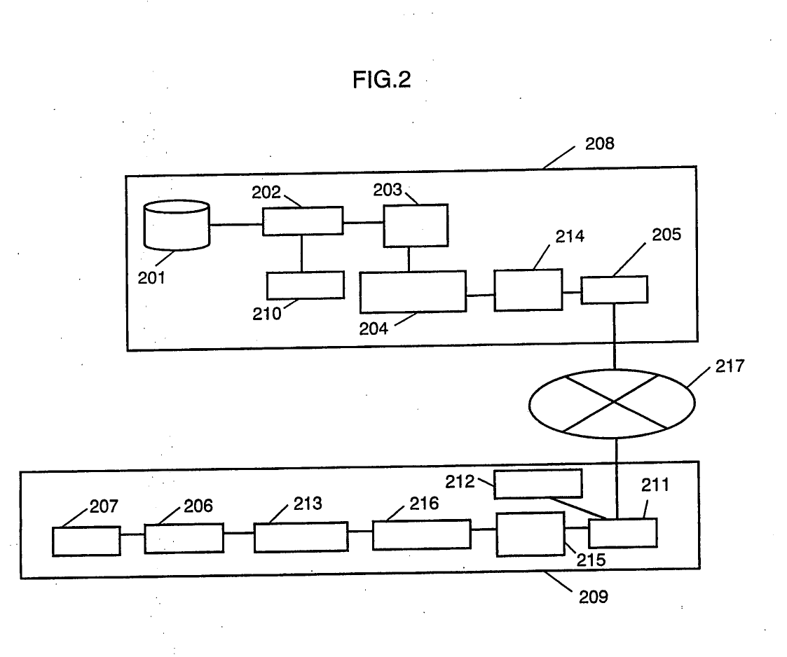

FIG. 2 is a configuration diagram showing a broadcast scheme in the first embodiment of the invention. Using FIG. 2, explanation will be made below on a content broadcast scheme added with header process in the first embodiment of the invention.

In FIG. 2, the content sent from a media transmitter 208 is received at a media receiver 209 via an IP network 217.

The media transmitter 208 is configured with a content storage section 201, a packeting section 202, a packet classifying section 203, a packet-header compressing section 204, a transmitting section 205, a broadcast managing section 210 and an interleave section 214.

The content storage section 201 is stored with the information (content) required in configuring a program, such as moving images, sound, still images, texts and the layout information thereof. Specifically, this section is a storage medium represented by a hard disk drive.

The packeting section 202 reads data out of the content storage section 201, and divides the content into transmission packets and provides them with headers. Concerning the header, an IP header is provided for a network layer while a UDP header is for a transport layer. An RTP header may be provided as a header in a higher-order layer.

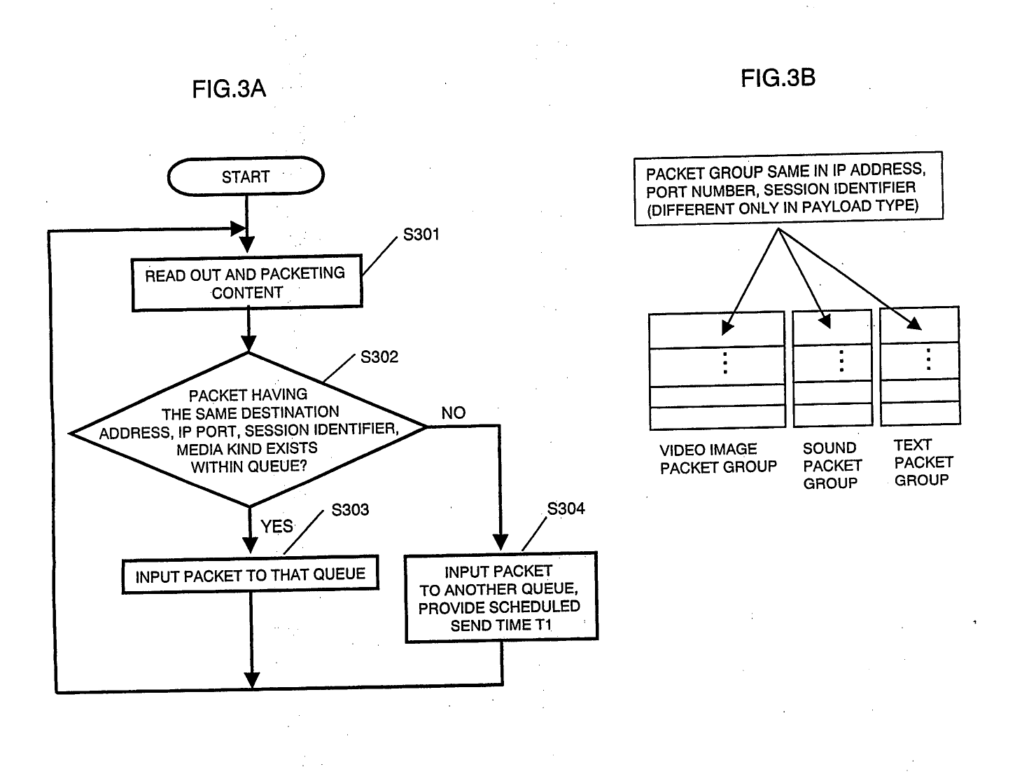

The packet classifying section 203 determines a transmission sequence of packets for the content from a viewpoint of header information, such as media kind (payload type), IP address, port number and session identifier. Namely, packets are arranged in order or classified into a plurality of queues shown in FIG. 3B based on the media kind, so that the packets destined for the same IP address or port can be sent by bundling as a series of packets.

The packet-header compressing section 204 has a plurality of classification queues shown in FIG. 3B, to realize header compression based on each classification queue. The classification queue is used for classification according to various kinds of classifications such as IP address, port number and session identifier. FIG. 3B shows an example used for classification based on each media kind. Incidentally, the method for packet-header compression used, for example, ROHC (Robust Header Compression: IETF RFC3095). This method can keep high header compression ratio where there is less change in header information.

The interleave section 214 is means for effecting interleave to the packet. Interleave refers to changing the sending order of packets. Because simply effecting interleave after header compression results in impossible header restoration, the present means carries out interleave based on a key frame of header compression. The key frame refers to a packet whose header, to be regularly inserted, has not been compressed during header compression.

The transmitting section 205 is an interface capable of transmitting data onto a communication or broadcast network.

The broadcast managing section 210 carries out management to start and end the broadcast. When a designated broadcast start time comes, this section instructs the packeting section 202 to start a broadcast. On this occasion, this section instructs the destination IP addresses and port numbers of various medias included in the content to the packeting section 202. This section has a function for a transmitter manager to set a start/end of broadcast (e.g. GUI setting, set function with setting files).

Meanwhile, the media receiver 209 is configured with a data reproducing section 206, an output section 207, a transmitting section 211, a program selecting section 212, a depacketing section 213, a header restoring section 215 and a packet orienting section 216.

The transmitting section 211 is an interface capable of receiving data from the communication or broadcast network. This section is means for opening a channel on the basis of a channel information notified from the program selecting section 212 and receiving a packet from the network to deliver it to the header restoring section 213.

The header restoring section 215 is means for decompressing the compressed header. The packet, containing a decompressed header, is delivered to the packet orienting section 216.

The packet orienting section 216 restores the interleaved packets into the former sequence. The information about a sequence for returning the packets to the former sequence can utilize the sequence number to be given upon packet generation, e.g. RTP sequence number.

The depacketing section 213 is means for taking data out of a received packet. This section removes headers, such as RTP, UDP and IP, and delivers a payload, as program data, to the data reproducing section 206.

The data reproducing section 206 is means for reproducing the data received from the depacketing section 213. Specifically, this section decodes moving images, sound, still images (and texts, if necessary), and delivers these pieces of information to the output section 207 by adjusting reproduce/display position and timing on the basis of layout information and synchronization information.

The output section 207 is means for presenting, to the user, the data received from the data reproducing section 206. Specifically, this section is a display device, such as a CRT display or an LCD display or a reproducing device, such as a speaker.

The program selecting section 212 is means for selecting a to-be-received program from among the programs on the air. Concerning program-list acquiring means for the programs on the air, it is omittedly shown in FIG. 2. However, a removal storage medium may be used to acquire it from another terminal unit. Otherwise, HTTP, SDP or other protocol may be used for acquisition through the transmitting section 211. Note that the program list is assumably described with the channel information for program reception (program-data destination addresses and port numbers), besides program names. The present means may be, for example, a GUI for the media-receiver user to select a program list or means for automatically select a program (e.g. one program in random). Namely, the program selecting section 212 is means for notifying the channel information about a selected program to the transmitting section 211.

Now, explanation will be made on the operation and function of the media transmitter and media receiver configured as in the above.

At first, the operation of the media transmitter 208 will be explained by using the drawings.

First, the broadcast managing section 210, at a designated broadcast start time, instructs the packeting section 202 to start a broadcast.

Then, the packeting section 202 receives this and reads designated data of from the content storage section 201, thereby dividing the content into transmission packets and delivering those added with headers to the packet classifying section 203.

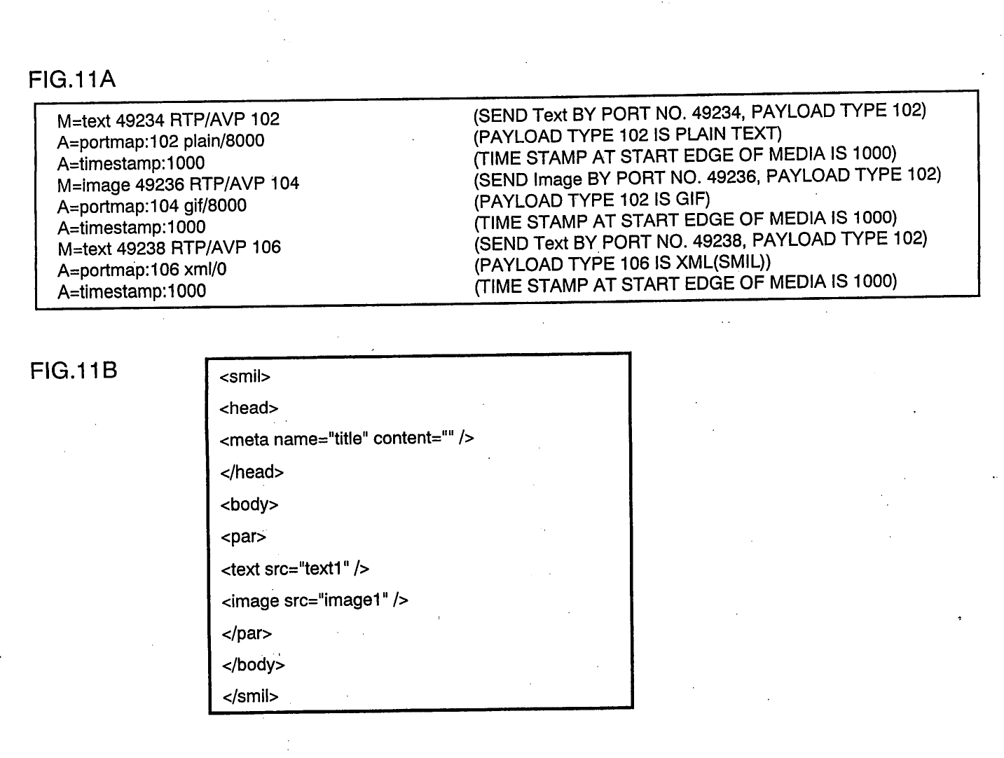

FIG. 11 shows an example of conventional program information representative of content attribute stored in the content storage section 201 and structure information representative of a structure between the medias.

In the example of program information of FIG. 11A, a text, an image and structure information are to be respectively transmitted wherein port numbers, payload types, etc. for use in respective media transmissions are shown (described in SDP/SAP). In the example of structure information of FIG. 11B, an example for combining a text and an image is described in SMIL.

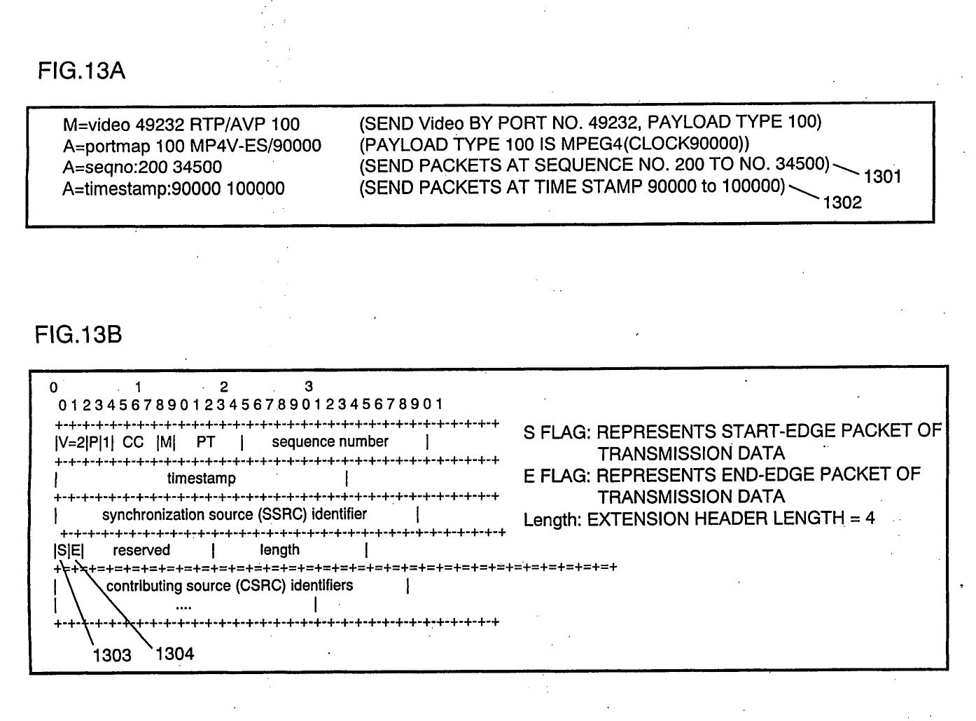

In this embodiment, as shown in FIG. 13A, identification information for identifying a start edge and end edge of transmission packets is further added to the program Attribute by SDP extension. Detection of a missing packet, hereinafter referred, is made possible at the media receiver 209 by the information at the start and end edges of the expanded sequence number 1301 representative of reproducing sequence and time stamp 1302 representative of reproducing time, the sequence number in a data packet header, and the time stamp.

Receiving this, the packet classifying section 203 outputs it to the classification queue based on the same IP address and port, thereby classifying the packets.

Then, the packet-header compressing section 204 carries out header compression on the packet, reaching the send time, of within the classification queue, and delivers them to the interleave section 214.

The interleave section 214 handles the received packets as segments based on each key frame, and rearranges the sequence based on the segment, thus delivering them to the transmitting section 205.

Subsequently, the transmitting section 205 forwards the packets of from the interleave section 214 onto the IP network. The transmitting section 205 repeatedly sends the same transmission packet whereby, in the event that a transmission packet is missed on the IP network, the media receiver 209 can detect it by using the identification information for identifying the start and end edges of the transmission packet thereby complementing for the content.

Herein, explanation will be made in detail on the packet classifying process to be made by the packet classifying section 203, the packet-header compression process by the packet-header compressing section 204 and the interleave process by the interleave section 214, by the use of the drawings.

FIG. 3A is a flowchart showing a packet classifying process.

First, according to an instruction from the broadcast managing section 210, the packeting section 202 reads the contents instructed for broadcast start out of the content storage section 201, and divides it into transmission packets and provides them with headers (step S301). The packets are delivered sequentially to the packet classifying section 203.

Then, the packet classifying section 203 checks the header of a received packet, to determine whether there is the same media kind, IP address, port number and session identifier of the packet already inputted to the classification queue shown in FIG. 3B as that of the packet generated at this time (step S302). In the case of existence, the packet generated this time is inputted to the same classification queue as that packet (step S303). In the case of nonexistence, input is to a vacant queue. On this occasion, a scheduled send time T1 is set to the classification queue (step S304). How to provide a send time is as per (Equation 1).
T1=(packet generated time)+(constant) (1)

This constant is determined in consideration of the transmission rate over the transmission line and the like.

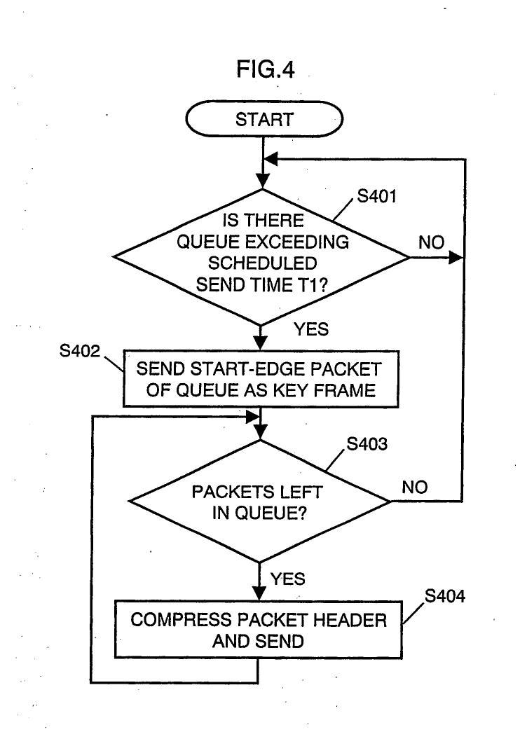

FIG. 4 is a flowchart showing the header compression process.

First, the packet-header compressing section 204 searches for a classification queue that the current time is over the scheduled send time T1 given to each queue (step S401). In the case of no detection, the process returns to the step S401. In the case of a detection, started is data transmission on the relevant classification queue. On this occasion, the packet at the start edge of within the classification queue is sent, without compression, as a key frame (step S402).

Next, check is made whether or not there are packets left in the classification queue (step S403). In the case there are packets left, the packets are compressed at the header and sent to the interleave section 214, and thereafter the process returns to the step S403 (step S404).

On the other hand, in the case no packets are left in the classification queue, the process returns to the step S401.

In this manner, provided is the contrivance that, once starting to forward a certain queue, packets are sent out until the queue becomes empty. This can enhance the header redundancy of successive packets and hence compression efficiency.

Incidentally, concerning the packet headers between the key frames, the differential to the one preceding packet header is forwarded as header information to the interleave section thereby realizing header compression.

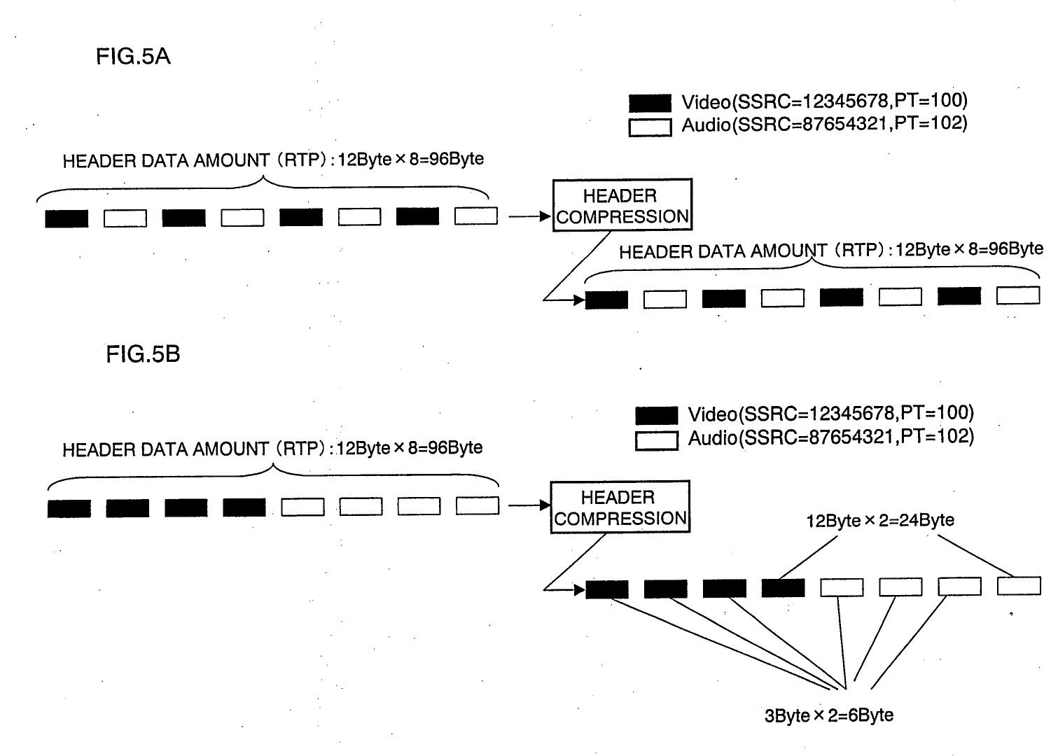

FIGS. 5A and 5B show a comparison in data amount between the case with header compression and the case without header compression.

In the header compression of FIGS. 5A and 5B, RTP header compression only is applied among the header compression schemes described in RFC2058. The packets of Audio and Video are to be sent on different SSRCs and payload types.

FIG. 5A shows a case that packets are sent irregularly during packet transmission wherein audio and video packets are sent alternately. In the scheme of RFC2058, because header compression is done on the premise there is no change in payload type and SSRC, the header after header compression does not have a field for transmitting a payload type or SSRC information (upon header decompression, provided is the SSRC and payload type of immediately preceding packet). Consequently, in the case that there is change in the payload type or SSRC, packets are sent without header compression. When transmitting data as shown in FIG. 5A, the headers cannot be compressed at all.

FIG. 5B shows an example that, during packet transmission, transmission is done with the packet classification according to the invention. In the illustrated example, because the packets having the same payload type and SSRC value are sent successively, header compression is possible. In the illustrated example, header compression is made from 12 bytes into 3 bytes on six packets, resulting in 54-byte reduction as compared to the case without classification.

As in the above, the present embodiment carries out header compression on the packets after classifying and bundling those having the same header information, such as media kind, IP address, port number and session identifier. Due to this, because the efficiency of header compression can be improved, it is possible to transmit even high-resolution quality data without the increase of the network transmission capability.

Incidentally, the packet classifying section 203 classifies and bundles packets according to the media type such that they are the same in media kind (payload type), IP address, port number and session identifier (e.g. SSRC in RTP/RTCP) but different only in payload type. Due to this, the packets of the same media type are to be sent in one series of packets, thus further improving the efficiency of header compression.

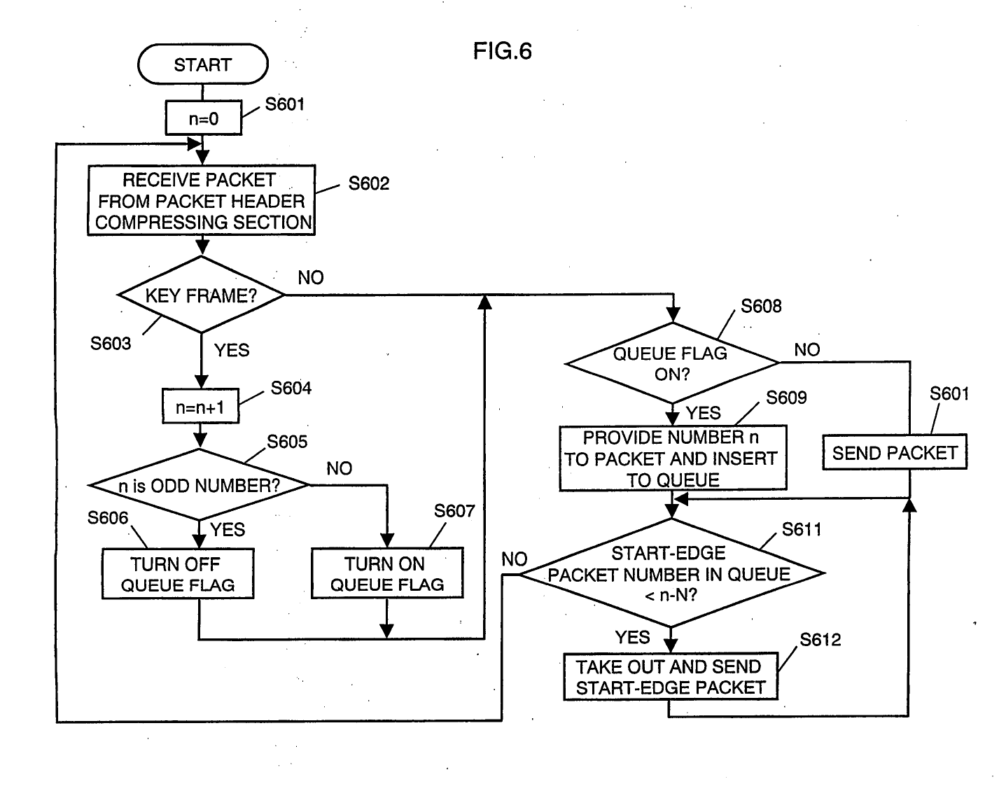

FIG. 6 is a flowchart showing the operation of interleave process. The interleave section 214 handles the packets of from a key frame, as a start-edge packet, up to the next key frame, as 1 block (hereinafter referred to as “chunk”), to thereby change the sequence of sending on each block basis. The interleave section 214 has a chunk counter n that counts the sequence number given to the chunk.

At first, in the interleave section 214, the chunk counter is initialized to ‘0’ in the initialization process (step S601).

Then, the interleave section 214 receives a packet from the packet-header compression section 204 (step S602).

Next, the interleave section 214 checks whether the received packet is a key frame or not (step S603). In the case of a key frame, ‘1’ is added to the chunk counter n (step S604).

Subsequently, it is checked whether the chunk counter n is an odd number or not (step S605). In the case of an odd number, a queue flag is turned off which is a flag for chunk-based processing (step S606). If an even number, the queue flag is turned on (step S607).

Next, it is checked whether the queue flag is in an on or off state (step S608). In the case the queue flag is on, a counter value of the chunk counter n is provided to the packet in order to identify of which chunk the packet is, and the packet is inputted to the queue for interleave (step S609).

On the other hand, in the case that the queue flag is off, the received packet is forwarded to the transmitting section 205 (step S610).

Then, it is checked whether the chunk identification number of a start-edge packet of the packets inserted to the queue (the value of the chunk counter given to the packet when inserted in the queue) is smaller than n−N (N: constant) or not (step S611).

In the case of the smaller, the start-edge packet is taken out and forwarded to the transmitting section 205 (step S612), and the process returns to the step S611.

On the other hand, in the case of not the smaller, the process returns to the step S602.

By the above process, the packets received from the packet-header compressing section 204 are forwarded in an amount of 1 chunk beginning at the key frame to the transmitting section 205. Thereafter, until receiving a packet of a chunk distant by predetermined N chunks, only the packets in an odd-numbered chunk are forwarded. The other received packets are stored to the queue for interleave. Thereafter, the packets preceding or succeeding by the predetermined number N of chunks are to be taken out of the interleave queue and forwarded, and the recent received packets are to be forwarded to the transmitting section 205. Due to this, the packets in a chunk distant by at least the predetermined number N of chunks can be rearranged for sequential output and then forwarded.

By thus correspondingly carrying out an interleave process and key frame generation upon header compression, the packets classified and bundled can be efficiently header-compressed and then interleaved based on the key frame generated upon header compression. Consequently, high header compression ratio can be kept despite carrying out interleave.

Meanwhile, by interleaving, the transmission loss in burst can be changed to a random transmission loss. The missing points of data are dispersed to lessen the trouble of viewing and listening. Furthermore, the countermeasure to packet loss can be readily realized.

Also, because of key-frame-based interleaving, the process of packet orientation, hereinafter referred, is facilitated in the media receiver.

Incidentally, although the above explained on the basis of each key frame, one interleave may be based on the transmission packets including a plurality of key frames. Furthermore, in the case of sending the information about error resistance, error resistance can be improved by using the information about error resistance as a key frame or sending it as a packet immediately preceding to the key frame.

The operation of the media receiver 209 will now be explained.

First, the transmitting section 211 receives the channel information about the program selected by the program selecting section 212 and receives the packets at the channel from the IP network.

Then, the header restoring section 213 decompresses the compressed header and delivers it to the packet orienting section 216.

Next, the packet orienting section 216 restores the interleaved packets received from the header restoring section 213 into the former sequence by using the provided sequence number, and delivers them to the depacketing section 213.

Then, the depacketing section 213 removes the headers from the packets received from the packet orienting section 216 and delivers the payload parts to the data reproducing section 206.

The data reproducing section 206 reproduces the data received from the depacketing section 213 and outputs it onto the output section 207, thereby effecting display or the like.

Herein, the configuration of the data reproducing section 206 will be explained in detail.

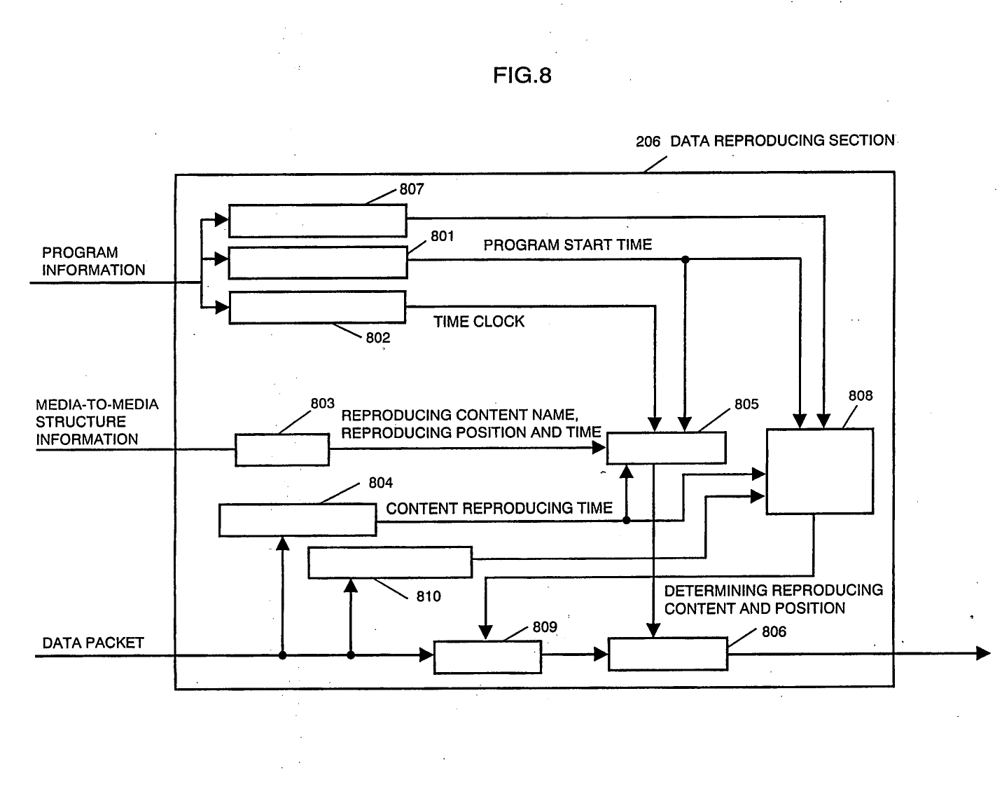

FIG. 8 is a block configuration diagram realizing the function of the data reproducing section 206.

A program start/end time acquiring section 801, receives program information, acquires the time stamps in the start-edge and end-edge packets of the medias described in the program information, and notifies them to the reproducing-time calculating section 805 and the missing-packet detecting section 808.

A time clock acquiring section 802 acquires a clock rate (clock count increase per second) of the time stamp contained in the RTP header of a received content, and notifies it to the reproducing-time calculating section 805.

A structure extracting section 803 determines a content to be reproduced, a content reproducing point (time) and the like from the information describing information about a structure between medias (e.g. layout information in position on the screen and time). For such a media as a text, video image or still image to be displayed on the display, this section takes a layout position out of the structure information and notifies it to the reproducing-time calculating section 805.

A time stamp extracting section 804 extracts a time stamp, as information about a reproducing time, from the received data packets.

A sequence number extracting section 810 extracts a sequence number, as information about a sequence of reproduction, from the received data packet.

A reproducing-time calculating section 805 calculates the reproducing timings of various medias from the information obtained from the above ones of means, and notifies the reproducing timings to the media decoding section 806. For a media, such as a text, video image or still image, to be displayed on the display, this section notifies a layout position to the media decoding section 806.

A media decoding section 806 decodes and arranges a media in a layout position in the reproducing timing obtained from the reproducing-time calculating section 805, and forwards it to the output section.

A sequence number acquiring section 807 receives program information and acquires the sequence numbers of the start-edge and end-edge packets of each media described in the program information, and notifies them to the missing packet detecting section 808.

A missing-packet detecting section 808 detects a missing transmission packet from the sequence numbers and time stamps of the start-edge and end-edge packets and the time stamps and sequence numbers of the data packet currently received, and notifies it to a data complement section 809.

A data complement section 809 extracts a notified missing transmission packet from the repeatedly sent data packets, and inserts the data thereof to a missing part. Of the above constituent elements, the program start/end time acquiring section 801, sequence-number acquiring section 807, time-stamp extracting section 804 and sequence-number extracting section 810 correspond to the acquiring section.

The operation of the data reproducing section 206 will be explained by using the drawings.

Incidentally, the below example is premised on that the media data, such as moving images, sound, still images and texts, is to be sent in a discrete RTP session based on each media. In this case, the clock rate of RTP time stamp assumably uses a value prescribed for each media (e.g. 90,000 Hz for video image, 8000 Hz for audio sound).

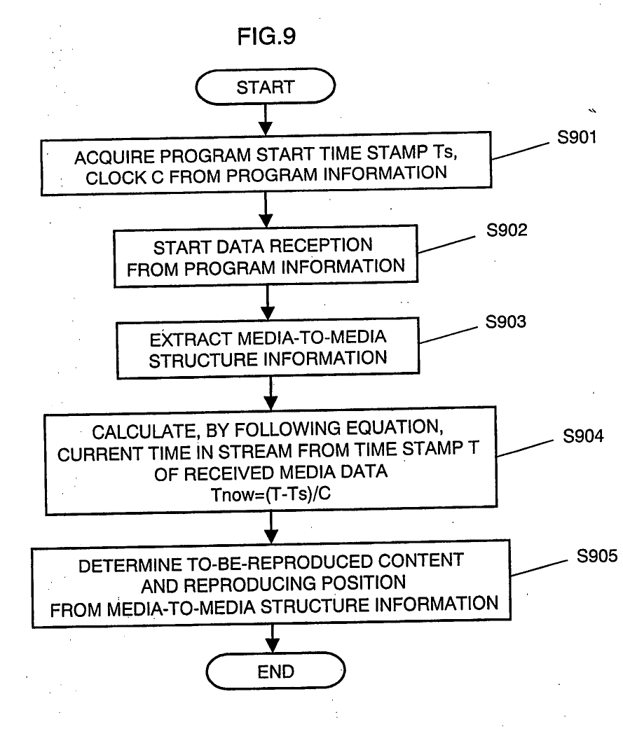

FIG. 9 is a flowchart showing a process procedure of the data reproducing section capable of reproducing in the halfway.

First, the program start/end time acquiring section 801 acquires a program-start time stamp Ts and clock C from the program information (step S901).

Subsequently, the media decoding section 806 starts data reception (step S902).

Next, the structure extracting section 803 extracts media-to-media structure information (step S903).

Then, the reproducing-time calculating section 805 calculates, by (Equation 2), a stream current time Tnow from the time stamp T at a start edge of the media data notified from the program start/end acquiring section 801 (step S904).
Tnow=(T−Ts)/C (2)

Then, the reproducing-time calculating section 805 determines a to-be-reproduced content and reproducing position from the media-to-media structure information (step S905).

As in the above, the data reproducing section 206 acquires a program-start time stamp from program information, calculates a current reproducing time from the time stamp and the received-data time stamp, and determines a to-be-reproduced content and reproducing position from the information describing a structure between a plurality of medias.

Now, explanation will be made on the procedure that the media receiver 209 enters a reception area in the course of a program and starts to receive it.

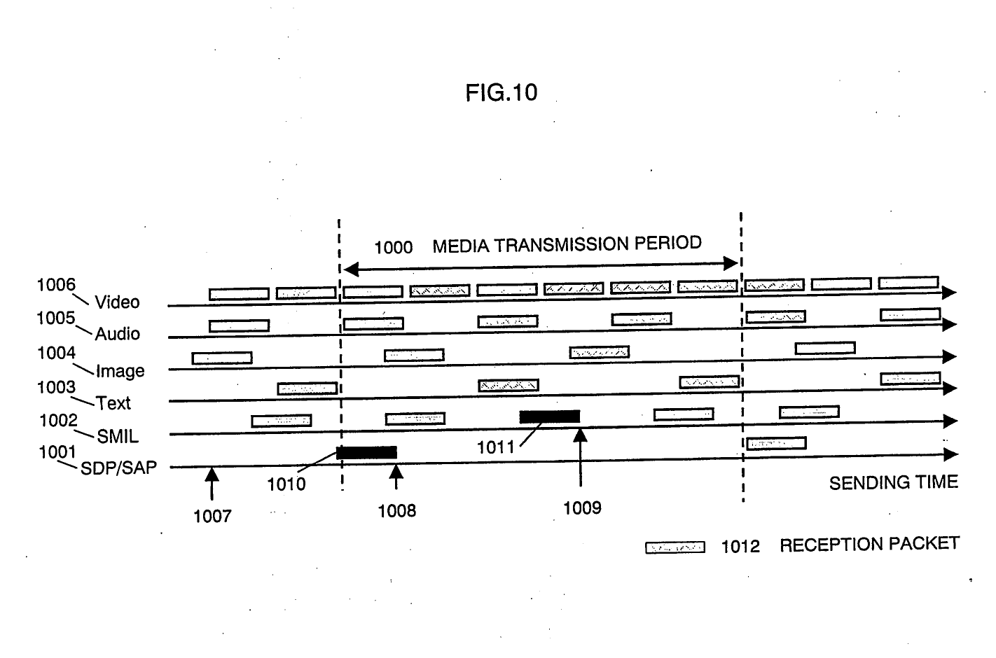

FIG. 10 is a figure explaining an operational relationship between program information about one program, structure information, how to send media data and data reproducing section capable of reproducing in the halfway. In FIG. 10, program information (SAP/SDP) 1001, structure information (SMIL) 1002, media data (Text 1003, Image 1004, Video 1006, Audio 1005) are being periodically sent with a media-transmission period 1000. Structure information 1002, Text 1003, and Image 1004 include all the pieces of information for restoring the relevant media contained in one packet. Also, Audio 1005 and Video 1006 are in stream transmission. Concurrently with streaming data transmission, program information and Image 1004 and Text 1003 information are being repeatedly sent with a media transmission period 1000, as shown in FIG. 10.

Now, explanation will be made on the operation that the media receiver 209, in such a situation of transmission, receives and reproduces program data.

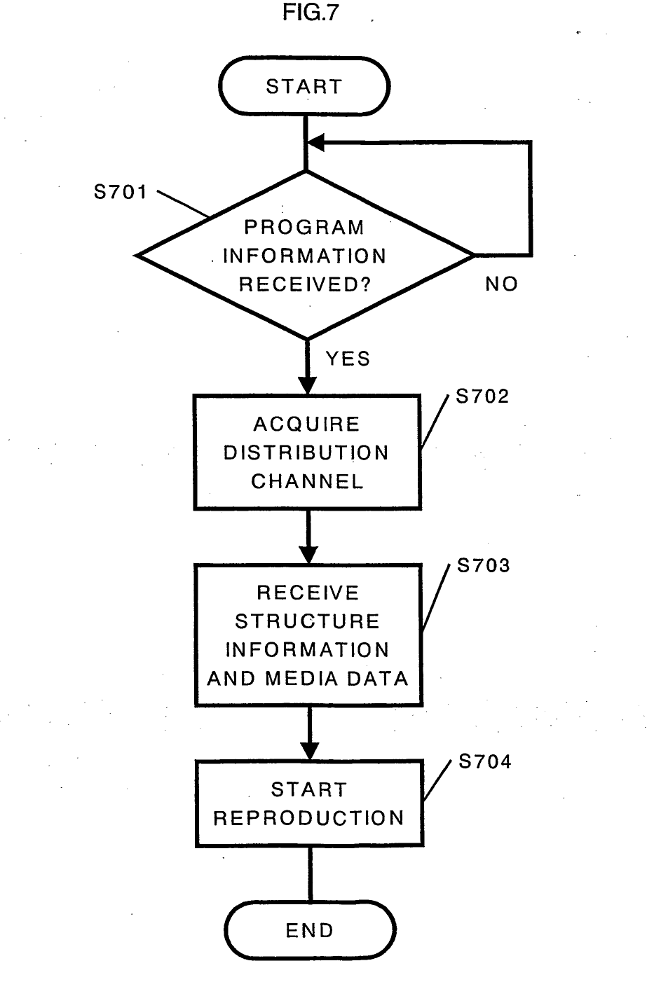

FIG. 7 is a flowchart showing a process of the media receiver 209 at this time.

First, the media receiver 209 assumably entered a data receivable area 1007 at a time point shown by 1007. In this reception area, contents are always being sent. However, the media receiver 209, unless receiving program information, cannot start content reception because it is impossible to know at which channel the content of a program is flowing. Consequently, the media receiver 209 checks for program information reception, which is to be repeated before reception (step S701).

Thereafter, the media receiver 209 at a time point shown at 1008 acquires program information 1010 and gets a channel through which a content is distributed from the program information 1010 (step S702).

The channel is opened, to receive structure information 1011 and media data (video pictures, sound, images, texts) (step S703).

Then, calculated is a relative time of a program by the procedure shown in FIG. 9, to start reproduction (step S704).

Thereafter, unless a request for reproducing another program is not made to the media receiver 209, the operation is ended.

Due to the above, even when the media receiver 209 enters a reception area in the course of a program to start reception, it can correctly reproduce the program in a mid course thereof.

Now, explanation will be made, by using the drawings, on the operation to compensate for the packet data missed over the IP network with the use of the media data or the like repeatedly sent with a media transmission period from the media transmitter 206.

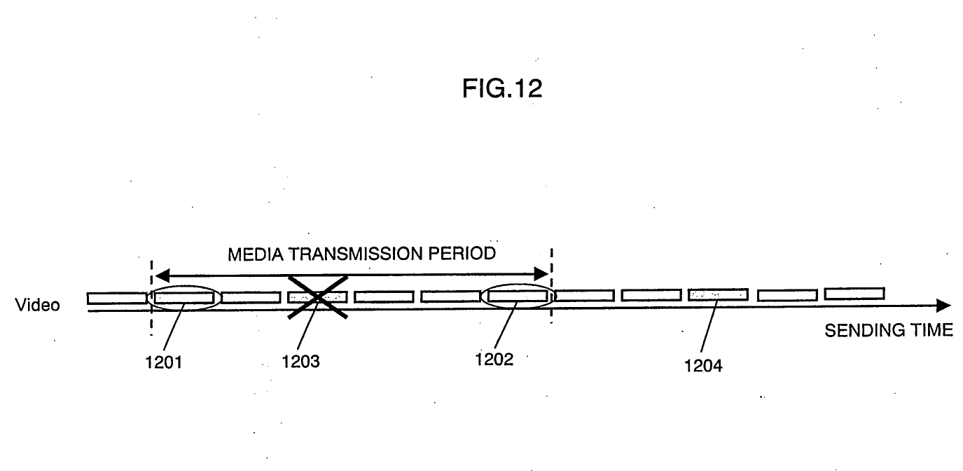

FIG. 12 is a figure explaining a method to complement the missing packet.

In FIG. 12, the media transmitter 208, upon repeated transmission, sends the same packets with the same sequence number and time stamp. Meanwhile, within the media transmission period, the sequence number and time stamp of the transmission packet increases linearly. When the next transmission period comes, the sequence number and the time stamp returns to a start edge.

Although the packets having the same time stamp includes consecutive several packets, these do not have an overlapped sequence number. Also, the sequence numbers at the start edge 1201 and end edge 1202 have been revealed from the extended program information.

Consequently, in the case of using RTP in sending a data string, the sequence number field has only 16 bits. Even where the sequence number makes a round in the course of data transmission to cause a plurality of packets having the same sequence number within the transmission period, determination is possible from a combination of a time stamp and a sequence number of a transmission packet at an end edge. Thus, it is possible to specify a missing transmission packet 1203.

This makes it possible to specify and compensate, in the next transmission period, a transmission packet same as the missing transmission packet from the sequence number and time stamp.

Meanwhile, the time stamp has a bit field of 32 bits. Even where making one round is impossible within the same content except that the content is considerably long (e.g. provided that the time stamp proceeds 90,000 per second, it takes 13 hours in making one round), it is impossible to specify a packet in a situation where the same content of data is repeatedly sent unless start and end edges of sequence numbers have been revealed. In such a case, the present embodiment effectively works in specifying transmission packet.

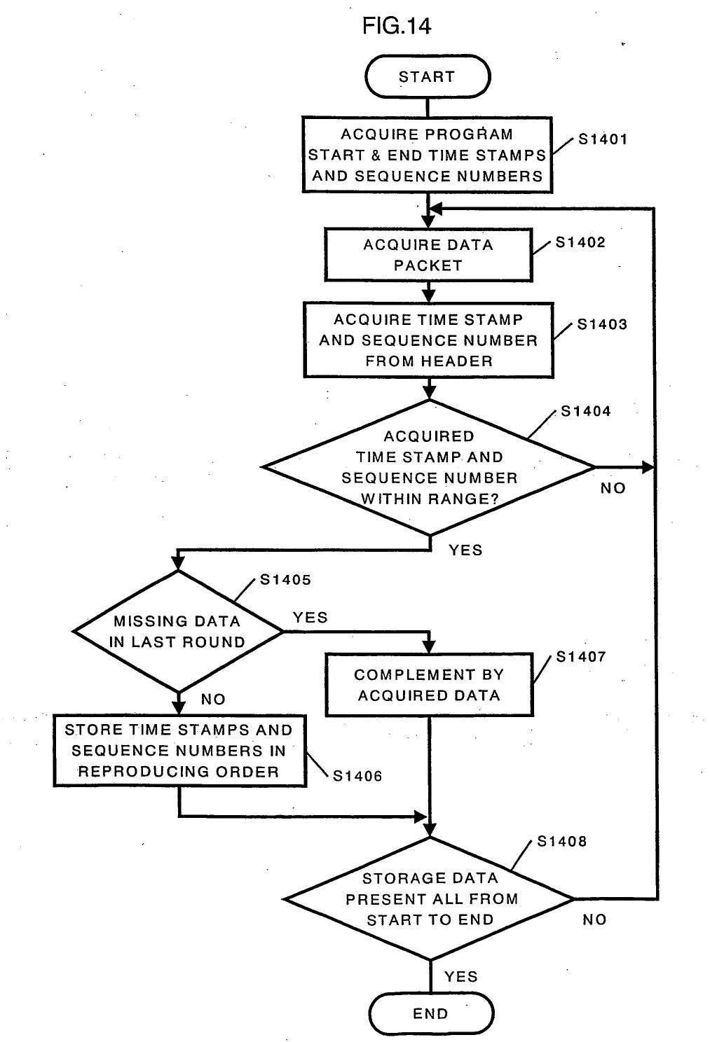

FIG. 14 is a flowchart showing a complement process for a missing packet to be executed in the data reproducing section.

First, the program start/end time acquiring section 801 and the sequence number acquiring section 807 acquires program start and end time stamps and sequence numbers (step S1401).

Next, the time stamp extracting section 804 and the sequence number extracting section 810 acquire a data packet (step S1402) and acquire a time stamp and sequence number from the header of the data packet (step S1403). The acquired time stamp and sequence number is notified to the missing-packet detecting section 808.

Then, the missing packet detecting section 808 checks whether or not the notified time stamp and sequence number is within a range of from a program start to an end (step S1404). In the case of not in the range, the process returns to the step S1402.

In the case of within the range, the missing-packet detecting section 808 checks whether or not the transmission packet specified by the notified time stamp and sequence number is a missing packet not having been acquired in the previous cycle (step S1405).

In the case of not a missing packet, the time stamp and sequence number is rearranged in a reproducing order and stored (step S1406).

On the other hand, in the case of a missing packet, notification is made to the data complement section 809, and the data complement section 809 insert the relevant data in a missed part and complement the same (step S1407).

Next, the missing-packet detecting section 808 checks whether or not the accumulated time stamps and sequence numbers are all present at from a program start to an end (step S1408). If not all present, the process returns to the step S1402. If all present, the missing-packet detecting section 808 makes a notification to the data complement section 809. The data complement section 809 ends the program data acquisition and delivers it to the media decoding section 806. The media decoding section 806 decodes the received data and forwards it to the output section 207.

Due to the above operation, in the event that the transmission packet efficiently sent by the media transmitter 208 is missed over the IP network, the media receiver 209 can restore it.

Incidentally, the transmission line in the present invention may be wired or wireless one. The media transmitters are not limited to the form to be connected to a particular transmission line. Furthermore, media receivers include those connectable to a plurality of kinds of transmission lines. The media receivers to which the invention is applicable are assumably various media receivers, such as TV sets, PDAs, cellular phones, car navigation systems and personal computers. Meanwhile, the program information, the layout information and various pieces of information including media data for passing over the transmission line may all be transmitted by using the same communication line or transmitted by using separate transmission lines.

(Second Exemplary Embodiment)

The present embodiment is different from the first embodiment in respect of the program information to be sent from the media transmitter to the media receiver and of the header data structure of media data.

FIG. 13B is a figure showing a data structure of the header of media data in this embodiment.

In FIG. 13B, by RTP extension, the lower order 2 bits in the time stamp is provided as bit flags 1303, 1304 of repeated start and end packets. This allows the media receiver to know the start-edge and end-edge packets of a content repeatedly sent, similarly to the first embodiment.

On the other hand, the program structure, not extended, remains in the conventional data structure shown in FIG. 11A.

These pieces of information and content data are data-compressed in the media transmitter 208 and interleave-processed, being sent to the media receiver in a repeated fashion.

The media receiver 208 is different from the first embodiment in that the depacketing section 213 detects, at a time of depacketing, the extended bit flags 1303, 1304 representative of start and end packets.

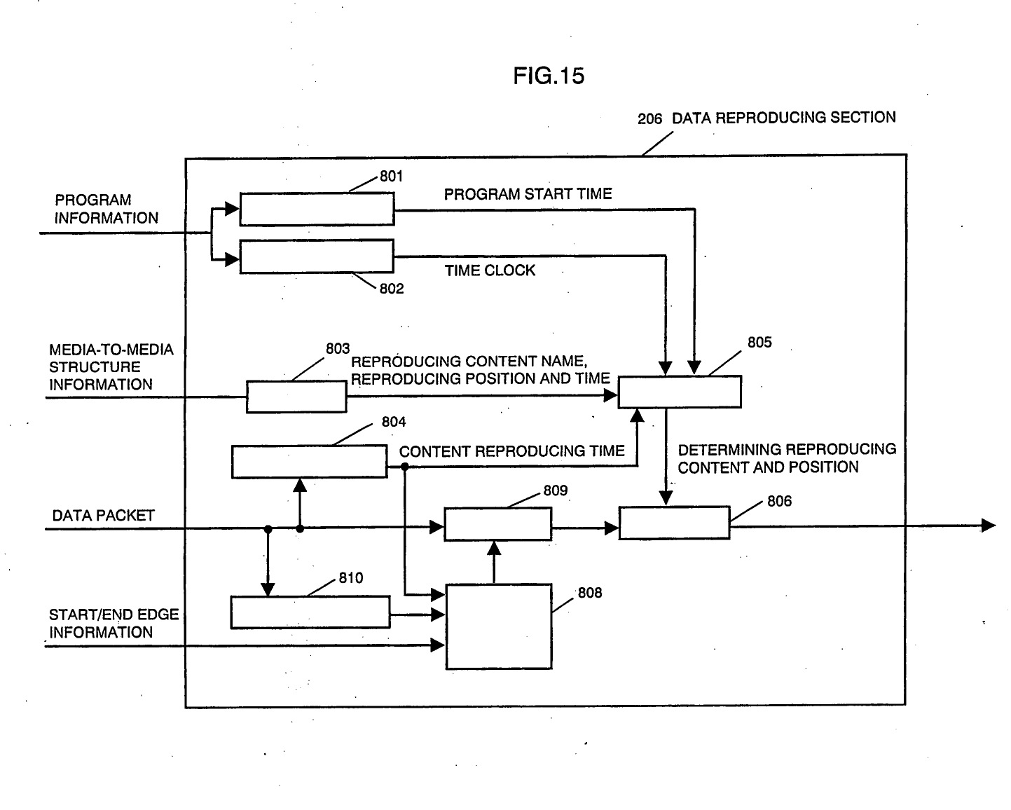

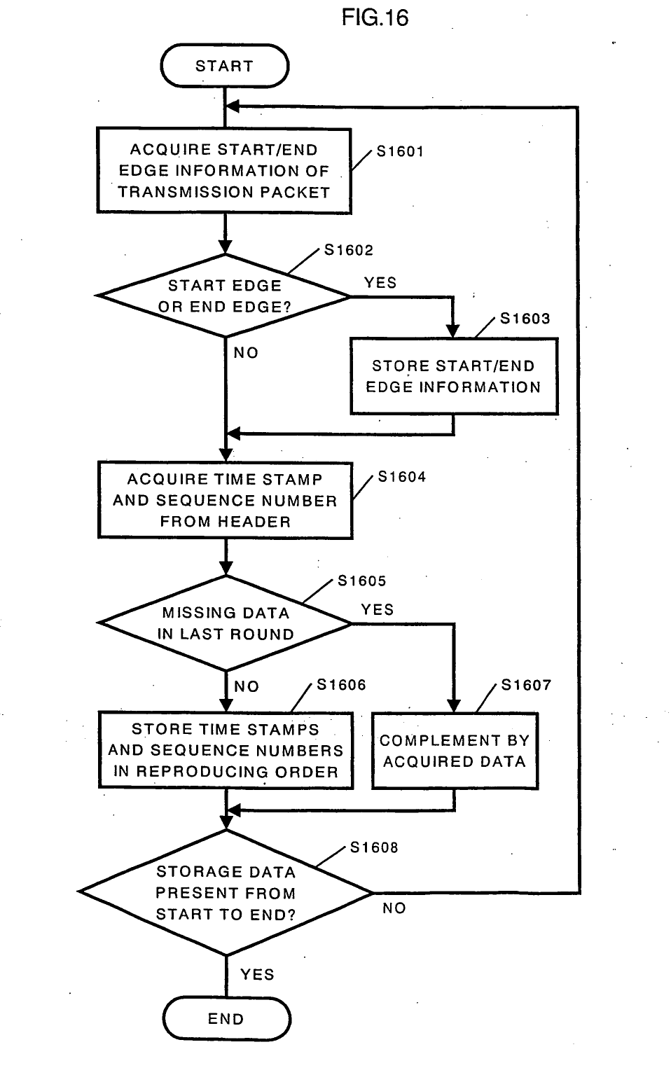

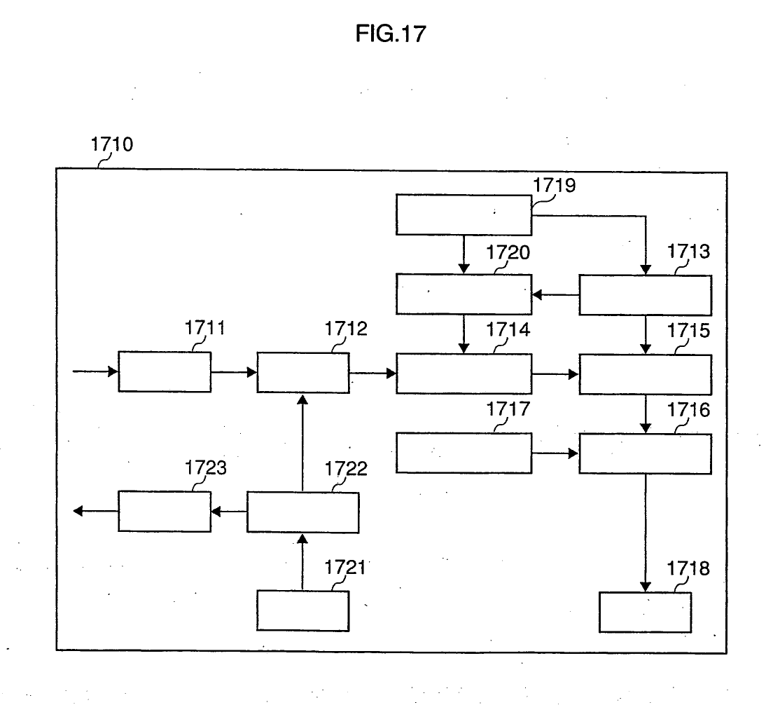

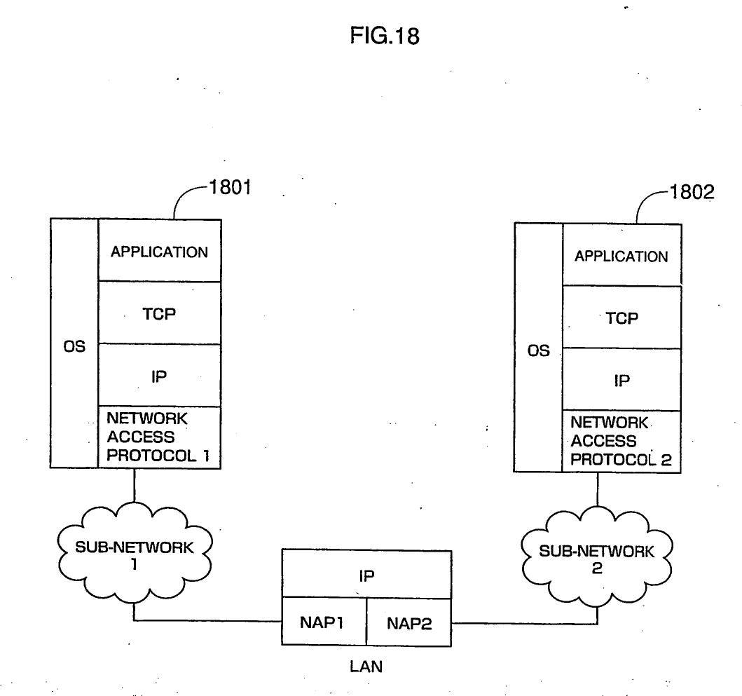

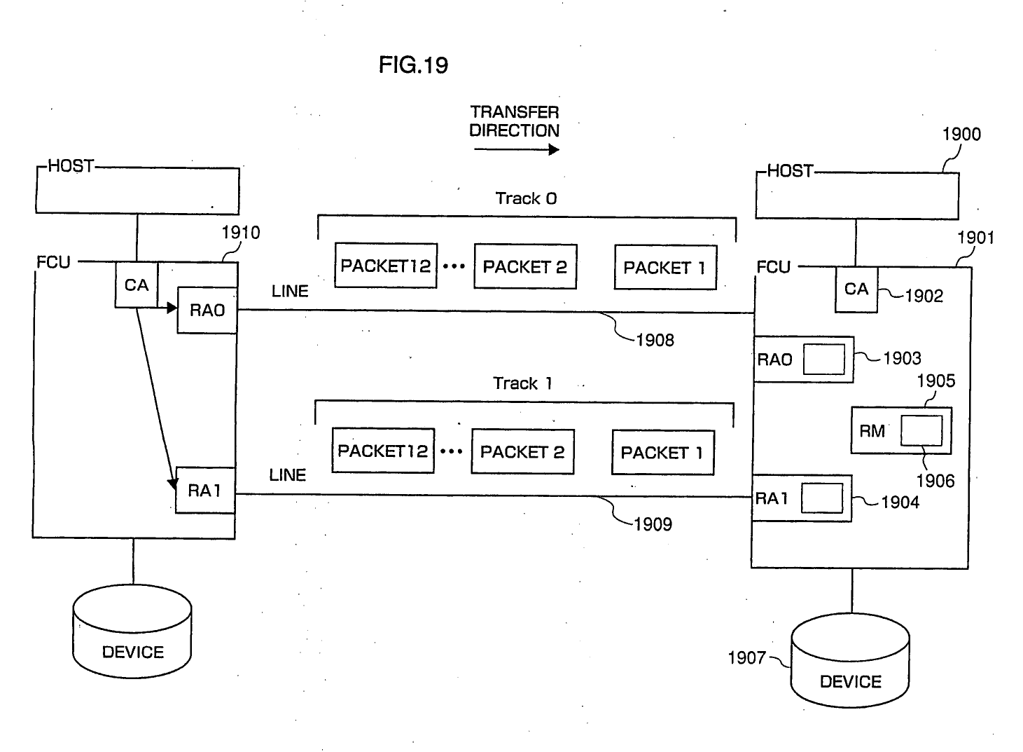

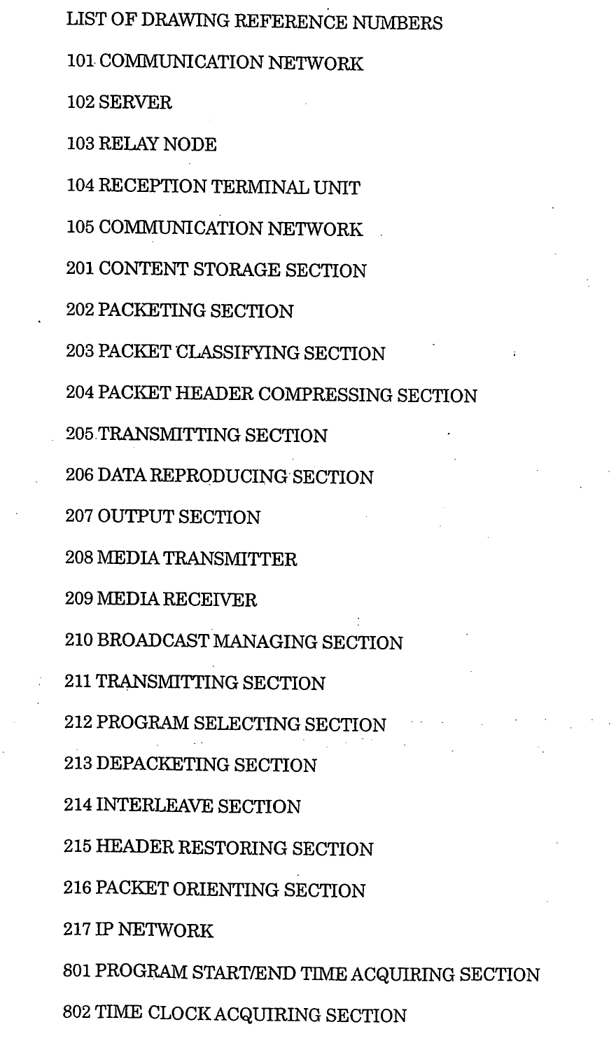

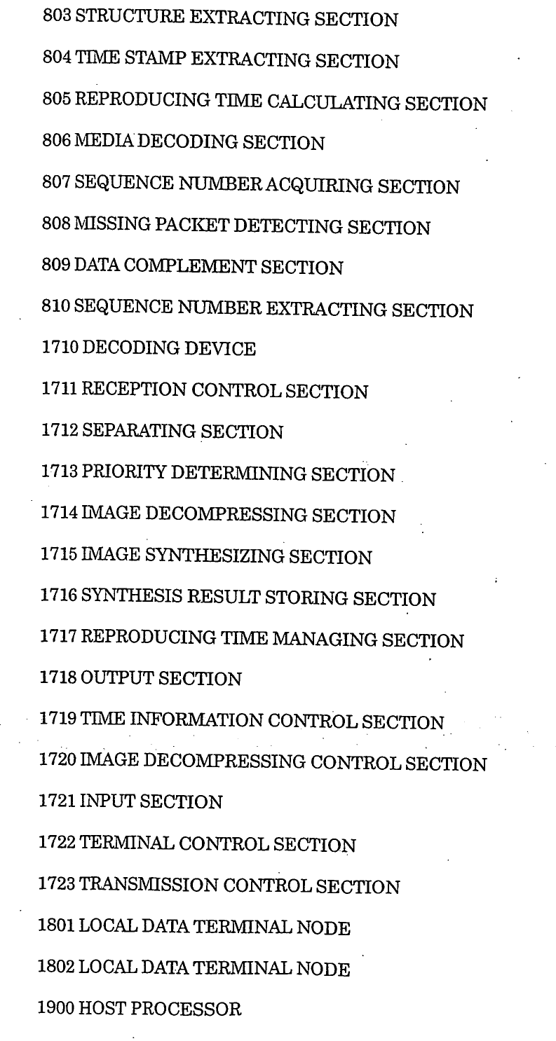

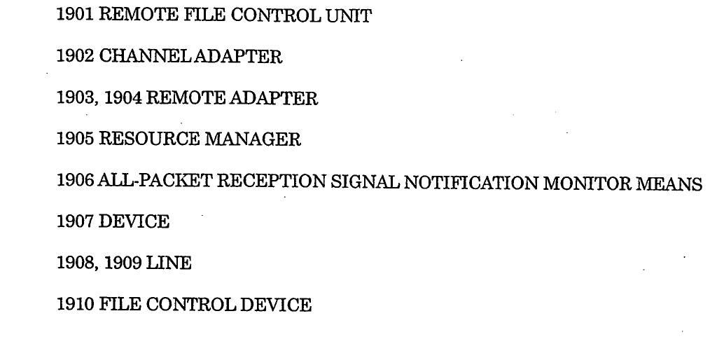

Also, the data reproducing section 206 has a block configuration shown in FIG. 15.

The missing-packet detecting section 808 is different from that of the first embodiment in that it acquires the information of a start and end of transmission packets from the depacketing section 213. Incidentally, of the constituent elements of the data reproducing section 206 of this embodiment, the program start/end time acquiring section 801, the time stamp extracting section 804 and the sequence number extracting section 810 correspond to an acquiring section.

Now, explanation will be made on the processes of missing packet detection and complement to be carried out by the media receiver 208, by using the drawings.

FIG. 16 is a flowchart showing a detection and complement process for a missing packet to be executed by the depacketing section 213 and data reproducing section 206.

First, the depacketing section 213 acquires the information of the bit flags 1303, 1304 representative of transmission-packet start and end edges from a transmission packet header (step S1601).

Next, the depacketing section 213 check from bit flags whether it is a transmission packet at either start edge or end edge (step S1602).

In the case of either one of transmission packet, the depacketing section 213 notifies it to the data reproducing section 206. The missing-packet detecting section 808 of the data reproducing section 206 receives the notification and stores the information thereof (step 1603).

Then, a time stamp and sequence number is acquired from the header of the data packet acquired by the time-stamp extracting section 804 and sequence-number extracting section 810 (step S1604). The acquired time stamp and sequence number is notified to the missing-packet detecting section 808.

Then, the missing-packet detecting section 808 checks whether or not the transmission packet specified by the notified time stamp and sequence number is a missing packet not having been received in the previous cycle (step S1605).

In the case of not a missing packet, the time stamp and sequence number is rearranged in a reproducing order and stored (step S1606).

On the other hand, in the case of a missing packet, the data complement section 809 is notified, and the data complement section 809 inserts the relevant data in a missed part and complements it (step S1607).

Next, the missing-packet detecting section 808 checks whether or not the accumulated time stamps and sequence numbers are all present at from a program start to an end (step S1608). If not present, the process returns to the step S1601. If present, the missing-packet detecting section 808 makes a notification to the data complement section 809, and the data complement section 809 ends the program data acquisition and delivers it to the media decoding section 806. The media decoding section 806 decodes the received data and forwards it to the output section 207.

Due to the above operation, in the event that the transmission packet efficiently sent by the media transmitter 208 is missed over the IP network, the media receiver 209 can restore it.

Meanwhile, in the present embodiment, the time stamp is usually counted up ‘1’ by ‘1’ on the order, per second, of 8000 Hz for sound and 90,000 Hz for the moving image. Consequently, there is no problem in case there is an error of lower order 2 bits or so (bit flags 1303, 1304 representative of start and end packets) added by RTP extension. Accordingly, the present invention can provide a method excellent in compatibility that, in case data is received by a media receiver not compatible with the extension, it has almost no effect upon the operation.

Industrial Applicability

As described above, the present invention is useful for a program broadcast using IP network with packet transmission, and suited in realizing a quality broadcast free of discontinuity in video image and audio sound, such as for a terrestrial-wave TV broadcast.

1. A media transmitting method, said method comprising the steps of:
classifying and bundling a content divided into transmission packets on the basis of header information of the transmission packet;
carrying out header compression on the transmission packets classified and bundled;
periodically inserting key frames, as transmission packets not to be carrying out said header compression, between the transmission packets to be carrying out said header compression; and
carrying out an interleave process on the transmission packets correspondingly to the key frames.

2. A media transmitting method according to claim 1, wherein the classifying and bundling step is done according to any of a media kind, IP address, port number and session identifier that are the header information.

3. (Cancelled)

4. (Cancelled)

5. A media transmitting method, said method comprising the steps of:
dividing content into a plurality of transmission packets,
adding to each one of said plurality of transmission packets, first identification information representative of said one of said transmission packets and second identifying information for identifying a start edge and an end edge of said one of said packets, and,
repeatedly transmitting said one of said packets.

6. A media receiving method, said method comprising the steps of:
receiving a repeatedly transmitted one of a plurality of packets having first identifying information representative of said one of said packets and second identifying information for identifying a start edge and an end edge of said one of said packets, and,;
extracting the first identifying information and second identifying information from the transmission packet;
detecting a missing transmission packet from the first identifying information and second identifying information; and
extracting and complementing the missing transmission packet from a next transmission packet repeatedly received.

7. A media transmitter comprising:
a packet classifying section for classifying and bundling a content divided into transmission packets on the basis of header information;
a header compressing section for having a function of carrying out header compression on the transmission packets classified and bundled, and a function of periodically inserting key frames, as transmission packets not to be carrying out said header compression, between the transmission packets to be carrying out said header compression; and
an interleave section for carrying out an interleave process on the transmission packets correspondingly to the key frames.

8. A media transmitter according to claim 7, wherein
the classifying and bundling step is done according to any of a media kind, IP address, port number and session identifier that are the header information.

9. (Cancelled)

10. (Cancelled)

11. A media transmitter, comprising:
a dividing unit a unit for dividing content into a plurality of transmission packets,
an adder for adding to each one of said plurality of transmission packets first identification information representative of said one of said transmission packets and second identifying information for identifying a start edge and an end edge of said one of said packets, and,
a transmitting section for repeatedly transmitting said one of said packets.

12. A media receiver comprising:
an input section for receiving a repeatedly transmitted one of a plurality packets having first identification information representative of said one of said packets and second identifying information for identifying a start edge and an end edge of said one of said packets,
an acquiring section for extracting the first identifying information and the second identifying information from the transmission packet;
a missing packet detecting section for detecting a missing transmission packet by using the extracted first identifying information and the second identifying information; and
a data complement section for extracting a next transmission packet repeatedly received.
